(19) United States
(12) Patent Application Publication
(10) Pub. No.: US 2023/0104964 A1
(43) Pub. Date: Apr. 6, 2023

(54) Multipurpose Currency Management System

(71) Applicant: Cash Depot, Ltd., Green Bay, WI (US)

(72) Inventor: David R. Charles, Green Bay, WI (US)

(73) Assignee: Cash Depot, Ltd., Green Bay, WI (US)

(21) Appl. No.: 17/532,408

(22) Filed: Nov. 22, 2021

Related U.S. Application Data
(60) Provisional application No. 63/252,107, filed on Oct. 4, 2021.

(51) Int. Cl. G07F 19/00; G06Q 10/00; G06Q 20/10

(52) U.S. Cl. CPC G07F 19/206; G06Q 10/30; G06Q 20/1085; G06Q 20/023

(57) ABSTRACT

A system and method for operating a currency management device of a service provider. The system includes a processing system, a memory, a user interface, a currency receiver, and a currency dispenser. The method can include the steps of receiving and dispensing currency as well as facilitating payment to third parties.

### CROSS-REFERENCE TO RELATED APPLICATION

The present disclosure is based on and claims priority to U.S. Provisional Patent Application No. 63/252,107 filed Oct. 4, 2021, the disclosure of which is incorporated herein by reference.

### FIELD

The present application relates to cash management systems, and particularly to currency management systems for retail environments.

### BACKGROUND

Retail and other cash-heavy businesses often have on-site automated machines configured to perform transactions and currency management activities on behalf of the business owner or consumers at the retail location. A common type of automated banking machine is a conventional automated teller machine (“ATM”). ATMs are increasingly used by consumers to conduct banking transactions, such as dispensing cash, making deposits, transferring funds between accounts, and making account balance inquiries. Additionally, automated point of sale (POS) terminals can accept payments from consumers in exchange for goods and/or services.

Other types of automated banking machines may be operated by users to carry out commercial transactions. These transactions may include, for example, the acceptance of large cash deposits and large cash withdrawals, the receipt of checks or other financial instruments, the dispensing of rolled coin, or other transactions required by users. A cash recycler, for example, can securely hold large amounts of cash on-site for use in the operation of the business. A smart safe can may be used for cash recycling purposes and can communicate with a financial network to credit a user's account upon a deposit or debit the user's account when cash is withdrawn by the user.

Businesses that take in relatively large amounts of cash usually employ cash handling services to periodically pick up the cash (e.g., using an armored car service) and to arrange for that cash to be deposited into a bank. Cash handling services may also be employed to maintain cash levels in ATMs for use by consumers.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a method of operating a currency management device of a service provider including a processing system, a memory system, a user interface device, a currency receiver, and a currency dispenser. The method can include the steps of receiving, via the user interface device, user identification from a user; determining, by the processing system, if the user is a known user stored in a database of known users; receiving, via the user interface, a transaction type selection from the known user; executing, by the processing system, stored instructions retrieved from the memory system based on the transaction type selection, the stored instructions including instructions for a currency recycling transaction and instructions for a payment transaction based on the transaction type selection; and performing a reconciliation to determine a currency inventory of the currency management device. The executing instructions for a currency recycling transaction can include receiving, via the user interface device, a recycling transaction amount from the known user; transferring, via at least one of the currency receiver and the currency dispenser, currency equal in value to the recycling transaction amount between the currency management device and the known user; and storing a currency recycling transaction record of the currency recycling transaction in the memory. The executing instructions for a payment transaction can include receiving, via the user interface, a payment recipient selection from the known user; receiving, via the currency receiver, currency as a user payment from the known user; sending, via the network, a request to transfer funds equal in value to the user payment from an account of the service provider to an account of the payment recipient; and storing a payment transaction record of the payment transaction in the memory. Performing the reconciliation can include determining, by the processing system, a net recycling transaction amount based on the currency recycling transaction records stored in the memory; sending a request to transfer funds proportional to the net recycling transaction amount between a user account and the service provider account; determining, by the processing system, a net payment transaction amount based on the payment transaction records stored in the memory; and determining, by the processing system, the currency inventory based on the net recycling transaction amount and the net payment transaction amount.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is an exemplary embodiment of a currency management system and method thereof according to the present disclosure.

FIG. 2 is a schematic representation of an exemplary control system according to the present disclosure.

FIGS. 3-11 are example process flows for operating the currency management system of the present disclosure.

### DETAILED DESCRIPTION

In the present description, certain terms have been used for brevity, clarity and understanding. No unnecessary limitations are to be inferred therefrom beyond the requirement of the prior art because such terms are used for descriptive purposes only and are intended to be broadly construed. The different methods and assemblies described herein may be used alone.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C. Likewise, unless otherwise specified or limited, the terms “mounted,” “connected,” “linked,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “bottom,” “front,” “back,” “left” or “right” features is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally, use of the words “first,” “second”, “third,” etc. is not intended to connote priority or importance, but merely to distinguish one of several similar elements or machines from another.

Challenges currently exist relating to conventional ATMs. While suited for low-volume consumer transactions, conventional ATMs and other customer-facing machines often lack the capabilities needed to handle large deposits and withdrawals needed for retail cash management activities. Moreover, existing smart safes and other retail currency management machines require specialized operating platforms that are different than those used by ATMs. Thus, retailers who wish to utilize these devices are forced to purchase a plurality of different machines that are often individually managed, and using incompatible operating systems.

Upon recognition of the foregoing problems and challenges, the currency management system capable of conducting transactions for users and consumers described herein below was developed. Embodiments of the currency management system may be capable of running multiple operating platforms needed to conduct a variety of transaction types, as well as the required hardware to efficiently and securely perform these operations.

The systems and methods described herein are capable of performing multiple functions in a retail environment and may include providing retail users with access for deposit or withdrawal by identification (“ID”) number or card, cash management functions, automated teller machine functions, recycling, bank deposits, cryptocurrency sales, and/or sales of any item requiring acceptance of cash into the system. The systems and methods described herein may help to reduce or eliminate duplicate costs such as costs for courier maintenance and software. The system also allows the owner of the system to reduce or eliminate physical trips to the bank and tracking their cash deposits and withdrawals on a per person or per store basis, as well as recycling the store cash into the system to give to customers for reuse. The systems and methods may also allow for one or more reconciliations for one or more accounts selected from the accounts related to transactions processed via the system and/or one or more reconciliations for the accounts associated with all transactions processed via the system during a selected time period (e.g., daily at 5:00 PM including all account processed between 8:00 AM and 5:00 PM). In other words, the total cash in the system is accounted for and then may be divided into several “user buckets”, whether it be store deposits, store withdrawal, cryptocurrency sales, bank deposits, car payments, insurance payments such that the activities can occur at one system and machine and then match the totals and provide the data to each of the users. The system may also accept cash to dispense from the device and then recycle all that cash so that anyone that wants to take cash out, primarily customers or people cashing out cryptocurrency, can do so. The system can also include a smart safe component for the retail location and/or cash register interfaces. The system can include several functions including but not limited to: retail smart safe excepting cash drawer deposits and providing cash to retailer to supplement cash drawers; ATM operations; bank deposits; sales of things like cryptocurrency, insurance, installment payments (e.g. car payments, credit card payments or other loan payments) where a customer can make their payments in cash and be excepted at the unit; multiple bank depository functions (e.g., an environment where any number of banks can have their customers make cash deposits or withdrawals at this location); cash recycling; multiple operating platforms for each of the different functions of the user interface machine; and interfacing to individual users separately but combining balances within the machine for daily reconciliations.

Some example systems, processes, method steps, and/or apparatuses disclosed herein may be used, in whole or in part or in combination with other examples described herein, to facilitate and/or support one or more operations of a currency management system for a service operator. The system or a portion thereof can be located at a service provider's location such as near a point-of-sale area or in a safe room. The system can include an automated teller machine (ATM),

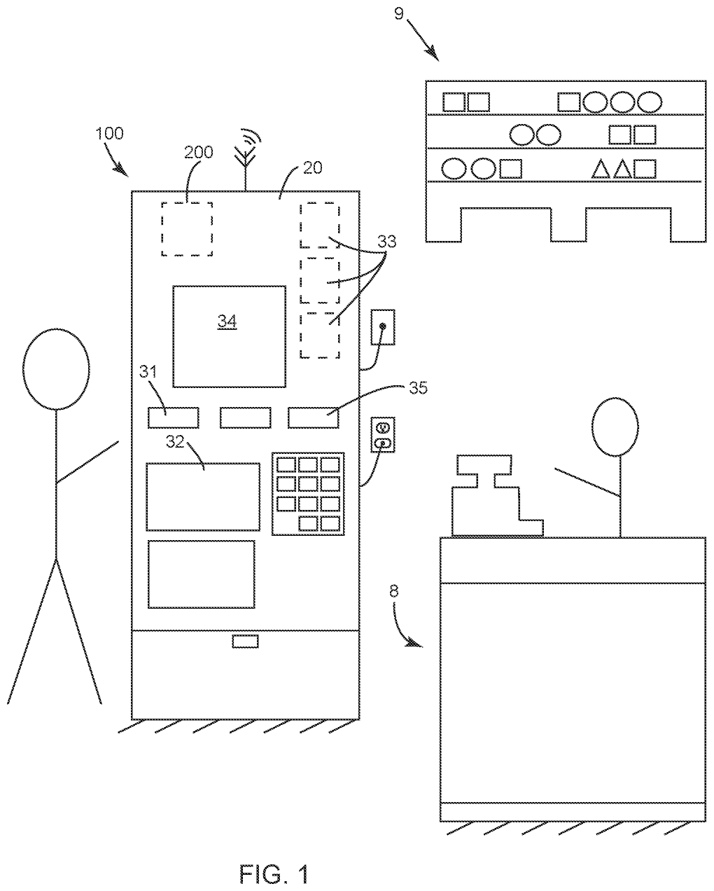

Referring to FIG. 1, an example currency management system 100 is depicted in a retail setting and is for facilitating various financial transactions with a consumer. The system 100 includes a currency management device 20 that is schematically depicted with several components that are described hereinbelow. The device 20 may be positioned near a point-of-sale (POS) station 8 and/or merchandise on retail shelving 9. Note that the device 20 may be free-standing or built into a wall, and the device 20 may abut a back-of-house area such that the service provider can access compartments and access doors (not depicted) on the rear of the device 20 apart from a retail environment. Operation of the device 20 may be facilitated through one or more computing and/or communication networks, such wireless networks, wired networks, or any combination thereof. Communication signals containing or corresponding to operation, transactions, processes, communications, and/or the like related to the device 20 are transferred to and from device 20 via the networks.

The system 100 is operated by a service provider that is an entity, such as an individual or retail store, that may handle currencies (e.g., physical currency such as bills and coins, electronic currency such as cryptocurrency) during its normal course of business. The service provider can engage the system 100 by directly interfacing with the device 20 or accessing the system 100 via a remote device, such as a cellular phone or laptop computer, or in the back-of-house area of the service provider. The service provider may be authenticated in some manner, such as prompted to verify its identity with a RFID identification card or entering an ID number, when interfacing with the system 100. In another example, the service provider may be prompted credentials into a user interface device (e.g., touch screen, keypad) of the device 20.

The system 100 can also be operated by one or more users (e.g., retail customers, consumers, guests, banking personnel) who may access the device 20 to perform financial transactions, some of which are described hereinbelow.

The system 100 can include one or more sub-systems that are described hereinbelow. Note that certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processing systems or other control devices. The connections between functional and logical block components are merely exemplary, which may be direct or indirect, and may follow alternate pathways.

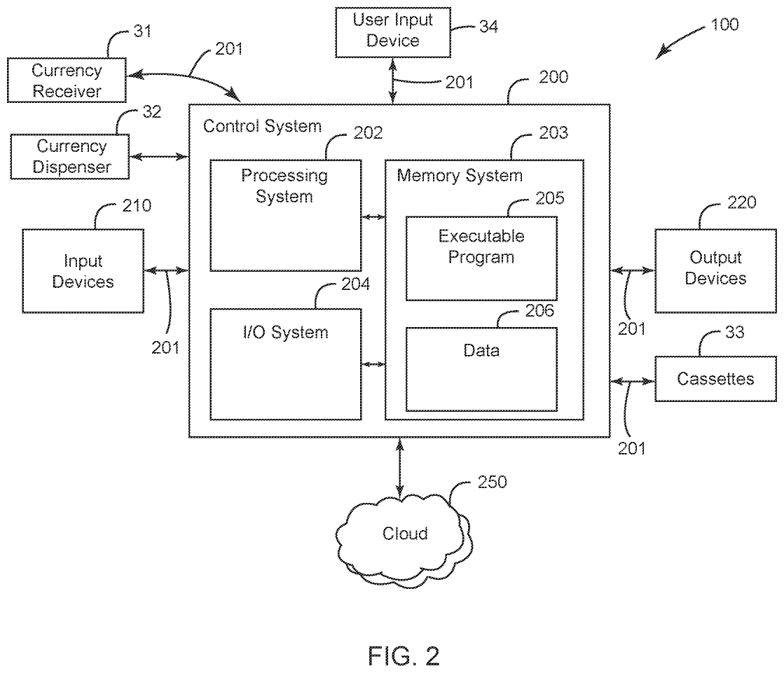

Referring to FIG. 2, in certain examples the system 100 includes a control system 200 that communicates with each of the one or more components of the system 100 via a communication link 201, which can be any wired or wireless link. The control system 200 is capable of receiving information and/or controlling one or more operational characteristics of the system 100 and its various sub-systems by sending and receiving control signals via the communication links 201. In one example, the communication link 201 is a controller area network (CAN) bus; however, other types of links could be used. It will be recognized that the extent of connections and the communication links 201 may in fact be one or more shared connections, or links, among some or all of the components in the system 100. Moreover, the communication link 201 lines are meant only to demonstrate that the various control elements are capable of communicating with one another, and do not represent actual wiring connections between the various elements, nor do they represent the only paths of communication between the elements. Additionally, the system 100 may incorporate various types of communication devices and systems, and thus the illustrated communication links 201 may represent various different types of wireless and/or wired data communication systems. Note that the device 20 can be connected to the network and/or cloud-based services.

The control system 200 may be a computing system that includes a processing system 202, memory system 203, and input/output (I/O) system 204 for communicating with other devices, such as input devices 210 and output devices 220, either of which may also or alternatively be stored in a cloud 250 via a wired or wireless network. The processing system 202 loads and executes an executable program 205 from the memory system 203, accesses data 206 stored within the memory system 203, and directs the system 100 to operate as described in further detail below. Note that the device 20 can be connected to the network and cloud via an ethernet cord plugged into a wall outlet, and the device 20 can receive electric power via a cord that plugs into an electrical outlets, or through any alternative source of energy such as batteries, generators and the like.

The processing system 202 may be implemented as a single microprocessing system or other circuitry, or be distributed across multiple processing devices or sub-systems that cooperate to execute the executable program 205 from the memory system 203. Non-limiting examples of the processing system include general purpose central processing units, application specific processing systems, and logic devices.

The memory system 203 may comprise any storage media readable by the processing system 202 and capable of storing the executable program 205 and/or data 206. The memory system 203 may be implemented as a single storage device, or be distributed across multiple storage devices or sub-systems that cooperate to store computer readable instructions, data structures, program modules, or other data. The memory system 203 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

Referring back to FIG. 1, the device 20 can include several devices the perform one or more functions in response to inputs and input signals received into the system 100. A currency receiver 31 is configured to receive currency into the currency management system 100, and a currency dispenser 32 is configured to dispense currency from the currency management system. One or more cassettes 33 within the device 20 are operatively connected to the currency receiver 31 and the currency dispenser 32 and configured to hold currency (e.g., bills or coins) received by the currency management system 100. A user interface device 34 (e.g., touch screen) is configured to receive inputs from the user and display information to the user. In certain examples, the currency receiver 31 comprises a currency validator configured to authenticate currency received by the currency receiver 31 as valid. The currency validator is for validating the currency by scanning the currency and/or processing data pertaining to the currency generated and/or received via the currency receiver 31 to determine if the currency is legitimate or fake. In certain examples, the cassette 33 is one of a plurality of cassettes 33 that are each operatively connected to the currency receiver 31 and the currency dispenser 32 and configured to hold currency in the system 100. One of the cassettes 33 is configured to hold a first type of currency (e.g., one-dollar bills) and another of the cassettes 33 is configured to hold a second type of currency (e.g., five-dollar bills).

The device 20 can also include wireless communication devices, such as near field communication transceivers and Bluetooth transceivers, for communication between the users and the system 100. The device 20 can also include a receipt printer 35.

Example process flows for performing various financial transactions with the system 100 via the device 20 are described hereinbelow. Note that the example process flows are described separately but other examples may include concepts and sequence steps from more than one of the example process flows. Moreover, steps shown in one process flows may be freely applicable for insertion into other process flows. Note that the example transactions may be based in traditional physical currencies and/or newer digital currencies.

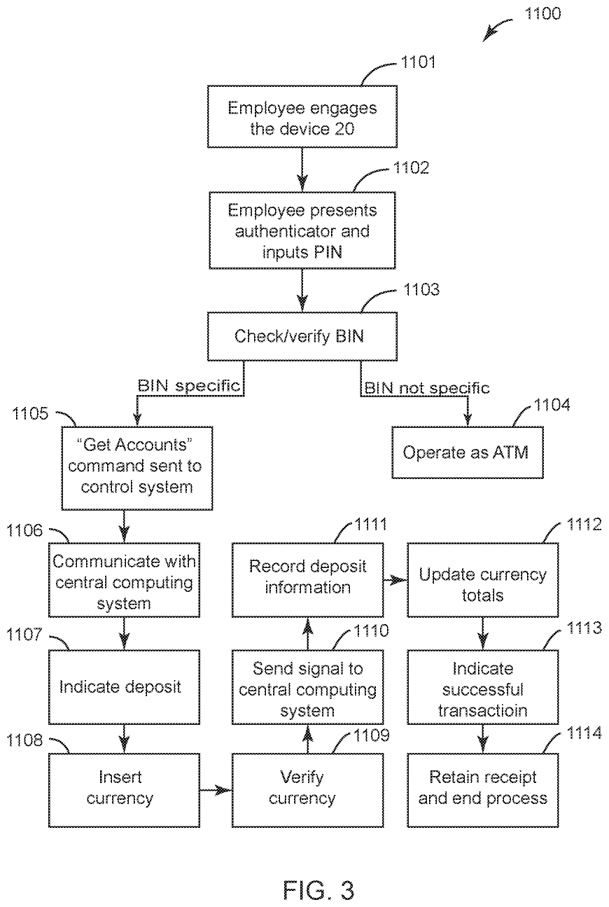

The first example process depicted in FIG. 3 to adding cash to the system 100 and specifically to one or more cassettes 33 (or another receptacle within the device 20). The process 1100 begins (at step 1101) by a service operator employee ending their shift by taking their till to the device 20. In step 1102, the employee presents an authenticator (e.g., RFID card) to the device 20, and accordingly, the system 100 loads one or more programs and/or data from the control system 200 that may correspond with identification data related to the employee. The system 100 via the user interface device 34 can request a personal identification number (PIN) or other verification code (e.g., pin code, facial recognition) from the employee. Note that the identification data related to the employee can include name, shift details, and/or access permissions. The system 100 at step 1103 checks and verifies one or more banking identification numbers (BIN) and determines if the BIN is specific to the system 100. BINs are generally the first four to six numbers on a payment card that identifies a financial institution that issues the card. As such, it matches transactions to the issuer of the card being used. BINs can be found on various payment cards, including credit cards, charge cards, and debit cards. If the BIN is not specific to the system 100, the device 20 will request that the user swipe their personal card to initiate a process (e.g., starts automated teller machine (ATM) functions or transactions (at step 1104)) for the duration of the employee's interaction with the device 20. Can we explain the reasons for the machine moving into an ATM function If the BIN is specific to the system 100, the device 20 sends “Get Accounts” command to the control system 200 (at step 1105). At step 1106, the control system 200 communicates signals with a central computing system (not depicted) that retains account numbers and balances available to access by the system 100. The central computing system can be on-site at the service provider, off-site, and/or in the cloud 250. The central computing system can be operated by a third-party financial institution, a privately managed database, and/or the like. The central computing system sends back a listing of accounts that only include one account labeled “Recycle Cash”. Note that ATM transactions can include making currency deposits, paying bills, transferring funds between accounts of the user, and/or the like.

The employee then inputs that a deposit will be made via prompts on the user interface device 34 (e.g., a graphical “Deposit” image may be selected by the employee) at step 1107. At step 1108, the employee inserts currency into the device 20 via the currency receiver 31, and the device 20 counts and verifies the currency (at step 1109). At step 1110, the device 20, via the control system 200, sends signals to the central computing system corresponding to the accepted currency such as count, type, and into which cassette 33 the currency is stored in the device 20. The central computing system records the transaction (a receipt of currency) at step 1111. The record of the transaction can include data corresponding to date, time, device ID, employee account number, cassette number, credit or debit, denomination, and/or currency count. At step 1112 the central computing system updates the currency totals for the cassettes 33 that received the currency. The device 20 indicates that the transaction was successful via the user interface device 34 and may print a receipt (at step 1113). At step 1114, the process ends and the employee places the receipt in their till for end of shift balancing.

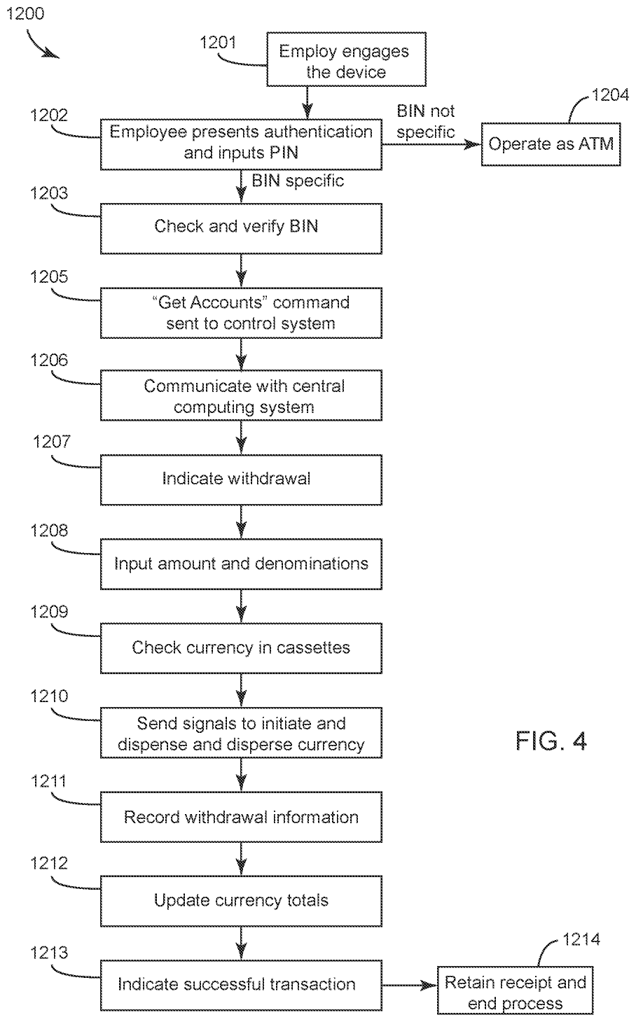

Referring now to FIG. 4, another example process for dispensing cash from the system 100 is depicted. The process 1200 begins (at step 1201) by a service operator employee starting their shift by taking their till to the device 20 to receive cash. In step 1202, the employee presents an authenticator (e.g., RFID card) to the device 20, and accordingly, the system 100 loads one or more programs and/or data from the control system 200 that may correspond with identification data related to the employee. The system 100 via the user interface device 34 may request a personal identification number (PIN) or other verification code from the employee. The system 100 at step 1203 checks and verifies one or more banking identification numbers (BIN) and determines if the BIN is specific to the system 100. If the BIN is not specific to the system 100, the device 20 defaults to automated teller machine (ATM) functions (at step 1204) for the duration of the employee's interaction with the device 20 as previously explained. If the BIN is specific to the system 100, the device 20 sends “Get Accounts” command to the control system 200 (at step 1205). At step 1206, the control system 200 communicates signals with the central computing system (not depicted). The central computing system sends back a listing of accounts that only include one account labeled “Recycle Cash”.

The employee then inputs that a withdrawal will be made via prompts on the user interface device 34 (e.g., a graphical “Withdrawal” image may be selected by the employee) at step 1207. At step 1208, the employee inputs the total withdraw amount and denominations via the user interface device 34. At step 1209, the device 20 via the control system 200 sends signals to the central computing system, and the central computing system checks currency count in the cassettes 33 and determines in the inputted withdraw amount and denominations can be dispensed via the currency dispenser 32. If inputted withdraw amount and denominations are available within the device 20, the central computing system sends controls signals to the device 20 and the control system 200 such that the currency is dispensed via the currency dispenser 32 at step 1210. The central computing system records the transaction (dispense of currency) at step 1211. The record of the transaction can include data corresponding to date, time, device ID, employee account number, cassette number, credit or debit, denomination, currency count, and/or the like. At step 1212 the central computing system updates the currency totals for the cassettes 33 from which the currency was dispensed. The device 20 indicates that the transaction was successful via the user interface device 34 and may print a receipt (at step 1213). At step 1214, the process ends and the employee places the receipt in their till for end of shift balancing.

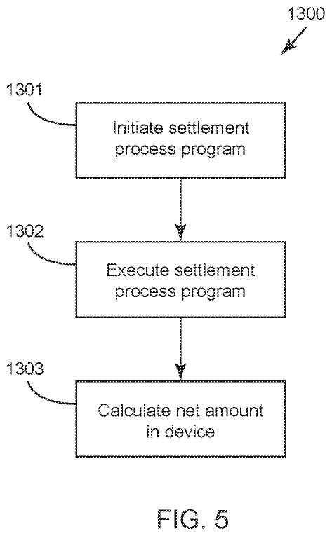

Now referring to FIG. 5, another example process for conducting a reconciliation or cash settlement process for the system 100 is depicted. The process 1300 begins (at step 1301) with the service operator initiating a settlement process program stored on the control system 200. At step 1302, the processing system 202 executes the settlement process program stored on the memory system 203 and communicates with the central computing system to access up-to-date information regarding the currency within the device 20. The control system 200 calculates the net amount within the device 20 of the system 100 (at step 1303) and at the calculated net amounts are added to the automated clearing house (ACH) transmissions that may include details regarding more than one transaction and is set out each day. The program then terminates.

An example of the calculation of the net amount within the device 20 is described below with reference to Table 1. In this example, the device 20 has four cassettes 33. One cassette 33 contains one-dollar bills, one cassette 33 contains five-dollar bills, and two cassettes contain twenty dollar bills. In this example, the settlement process program is initiated at 2:30 PM and thus the total value cells entered before this time are added together. The control system 200 calculates that the difference between the total value cells and total value recorded in the central processing system is $260.00. Accordingly, the settlement process program includes a step of debiting the service provider $260.00 to account for settlement the account and further updates the total value recorded in the central processing system.

TABLE 1

| | | Employee | | | | | | | |
|---|---|---|---|---|---|---|---|---|---|
| Terminal | | Card | Account | | | | | Total | |
| ID | Date/Time | ID | ID | [symbol] | [symbol] | [symbol] | [symbol] | Value | Description |
| [symbol] | [symbol] | [symbol] | [symbol] | | | | | [symbol] | [symbol] |

[symbol]

indicates data missing or illegible when filed

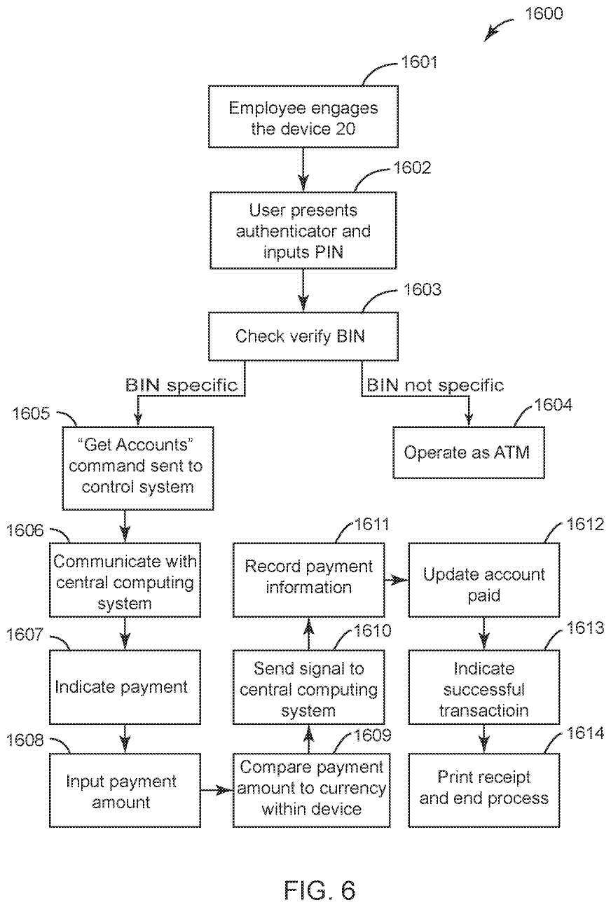

Referring now to FIG. 6, another example process for making payments to third-party businesses is depicted. The process for making payments to third parties allows the service provider to submit payment to third parties. The third parties can include utility companies, banks, loan servicers, and the like. The payments can be initiated after currency is deposited into the device 20 or by conducting an electronic withdrawal process from a debit card account. The funds are sent to the third party businesses through ACH processing, and the system 100 reports additional data/details to the third parties so that the third party can associate each payment to the account holder's profile. An example process 1600 begins (at step 1601) by a user (e.g., consumer, service provider employee) engaging the device 20 of the system 100. In step 1602, the user presents an authenticator (e.g., RFID card) to the device 20, and accordingly, the system 100 loads one or more programs and/or data from the control system 200 that may correspond with identification data related to the user. The system 100, via the user interface device 34, requests a personal identification number (PIN) or other verification code from the user. The system 100 at step 1603 checks and verifies one or more banking identification numbers (BIN) and determines if the BIN is specific to the system 100. If the BIN is not specific to the system 100, the device 20 defaults to automated teller machine (ATM) functions (at step 1604) for the duration of the user's interaction with the device 20. If the BIN is specific to the system 100, the device 20 sends “Get Accounts” command to the control system 200 (at step 1605) to retrieve accounts associated with the BIN.

At step 1606, the control system 200 communicates signals with the central computing system (not depicted). The central computing system sends back a listing of accounts either associated with the BIN or with the user's authentication information that require payment or have an outstanding balance. The central computing system may also provide several options for linking to third-party databases via internet webpages such that the user can pay accounts at third-party webpages that are not available via the central computing system. The user then inputs that a payment will be made via prompts on the user interface device 34 (e.g., a graphical “Pay Account” image is selected by the user) at step 1607. At step 1608, the employee inputs the total amount to be paid via the user interface device 34. At step 1609, the device 20 via the control system 200 sends signals to the central computing system, and the central computing system checks currency count in the cassettes 33 and determines if the inputted payment amount can be paid. If the inputted payment amount is less than or equal to the amount with the device 20, the central computing system sends pay indication to the selected account at step 1610. However, if the inputted payment amount is greater than the amount with the device 20, the central computing system requests additional information (e.g., debit card account) to thereby make up the difference and pay the account. The central computing system records the transaction (payment) at step 1611. The record of the transaction can include data corresponding to date, time, device ID, employee account number, cassette number, credit or debit, denomination, currency count, and/or the like. At step 1612 the central computing system updates status of the account that was paid and the account of the device 20. The device 20 indicates that the transaction was successful via the user interface device 34 and may print a receipt (at step 1613). At step 1614, the process ends.

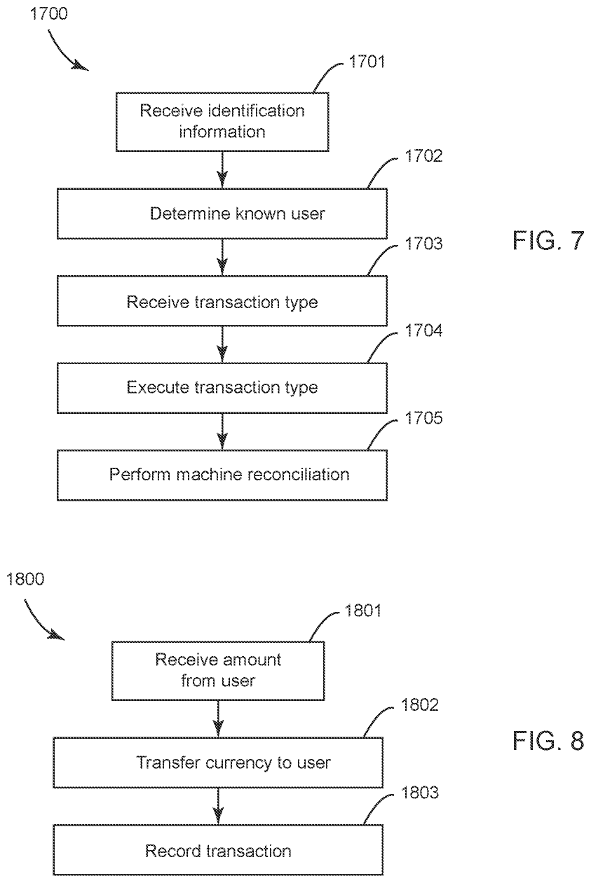

Referring to FIG. 7, another example process for the operating the system 100 for dispensing cash is depicted. The process 1700 begins by starting at step 1701 by receiving, via the user interface, user identification data from a user of the system 100. The user identification can include data pertaining to personal information (e.g., name, birthdate), account information, and the like of the user. At step 1702, the processing system 202 of the control system 200 determines if the user is a known user stored in a database of known users. The database of known users is stored on the memory system 203 or the central processing system and the database of known users includes data for each user including name, shift, hire date, access permissions, and/or other information related to the user. The user interface device receives a transaction type selection (e.g., deposit, withdraw) from the known user at step 1703. The processing system 202 executes stored instructions retrieved from the memory system 203 or the central computing system based on the transaction type selection at step 1704. The stored instructions can include instructions for several different operations such as instructions for a currency recycling transaction and instructions for a payment transaction (described therein). The processing system 202 further performs a reconciliation (described therein) to determine at step 1705 based a currency inventory of the currency management device 20 and the selected transaction type. The currency inventory can include a count of all types of currency within the device 20 such as number of coins (e.g., fourteen dimes, fifty quarters) and the number of bills (e.g., one hundred one-dollar bills, five hundred one-hundred-dollar bills). The currency inventory can also include the currency counts for each jurisdiction (e.g., the device 20 can hold United States currency and Canadian currency).

FIGS. 8-10 depict example processes for executing stored instructions for the currency recycling transaction, the payment transaction, and/or the reconciliation. Referring specifically to FIG. 8, the process 1800 for executing instructions for a currency recycling transaction includes at step 1801 receiving, via the user interface device 34, a recycling transaction amount from the known user. The control system 200 transfers at step 1802 currency equal in value to the recycling transaction amount between the device 20 and the known user. At step 1803 the control system 200 stores a currency recycling transaction record of the currency recycling transaction in the memory system 203. The currency recycling transaction record includes information or data pertaining to the currency recycling transaction such as value of currency transferred, time, date, and/or any other data pertaining to the currency recycling transaction. In certain examples, the currency recycling transaction amount is the amount of currency received into or dispensed from the device 20.

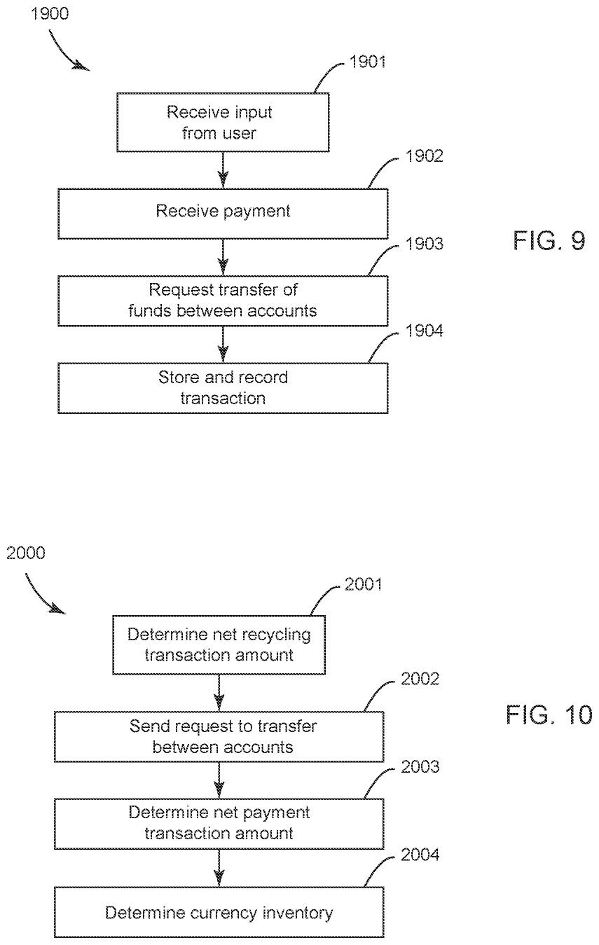

Referring specifically to FIG. 9, the process 1900 for executing instructions for a payment transaction includes the step 1901 of receiving, via the user interface device 34, a payment recipient selection from the known user. The instructions for the payment transaction can include instructions for performing an electronic payment (described herein below) and/or a physical currency payment (described herein below). The payment transaction can be any type of payment from the user to another third party or the service provider. In non-limiting examples, the payment transaction is a monthly car loan payment from the user to a care loan servicer or mortgage loan payment from the user to a mortgage holder. Note that the payment recipient selection by the user corresponds to the recipient of the payment (e.g., payment recipient) and the payment recipient can be another user, the service provider, a financial institution, and/or any other third-party or account thereof. At step 1902, the currency receiver 31 receives the currency as a user payment from the known user. The control system 200 sends signals to a central computing system to request to transfer funds equal in value to the user payment from an account of the service provider to an account of the payment recipient at step 1903. At step 1904, the control system 200 stores a payment transaction record of the payment transaction in the memory system 203. The payment transaction record includes value transferred, time, date, and/or any other data pertaining to the transaction.

Referring specifically to FIG. 10, the process 2000 for executing a reconciliation includes step 2001 of determining, by the processing system 202, a net recycling transaction amount based on the currency recycling transaction records stored in the memory system. In one example, the reconciliation is for reconciling data and/or the account for a user, the account of the service provider, and/or the account(s) of one or more financial institutions. The net recycling transaction amount which is the sum of the currency in the device 20. At step 2002, the control system 200 sends request to transfer funds proportional to the net recycling transaction amount between a user account and the service provider account. The user account is unique to the user operating the device 20 and the service provider account is unique to the service provider who operates and/or owns the device 20. The processing system 202 determines at step 2003 a net payment transaction amount based on the payment transaction records stored in the memory system. At step 2004, the processing system 202 determines the currency inventory by comparing the net recycling transaction amount and the net payment transaction amount (see also FIGS. 8-9). The net recycling transaction amount can be the summation of the deposit(s) and/or withdraw(s) of currency during currency recycling transaction. Note that in certain examples the user account including information and details thereof can be part of or hosted by the service provider or a financial institution.

The processes described above can further one or more additional steps. In one example, the currency recycling transaction is a deposit and transferring currency is between the device 20 and the known user such that the process includes the steps of receiving, via the currency receiver 31 a currency deposit from the known user and verifying, with the currency receiver 31, that the currency deposit is equal in value to the recycling transaction amount. In another example, the currency recycling transaction is a withdrawal and transferring currency is between the device 20 and the known user such that the process includes the steps of retrieving a user account balance from a financial institution associated with the user; verifying, with the processing system 202, that the user account balance is greater than the recycling transaction amount; and dispensing, with the currency dispenser 32, currency equal in value to the recycling transaction amount from the device 20. Note that retrieving the user account balance from the financial institution can be executed by the control system 200, and in other examples, control system 200 retrieves the financial information is stored locally on the memory system 203. The financial institution can be any type of company or entity that deals with financial transactions such as banks, credit union, investment banks, brokerage firms, insurance companies, and mortgage companies.

In another example, the process step of executing instructions for the currency recycling transaction further includes sending a currency recycling transaction record to a financial institution associated with the user. The currency recycling transaction record includes details related to the currency within the device 20, time, date, and any other data pertaining to the transaction. Note that sending the record(s) can be executed by the control system 200 and the record(s) can be sent to the central computing system and/or the financial institution. In another example, the process step of executing instructions for a payment transaction further includes authenticating, with the currency receiver 31, the user payment as valid. The authenticating the user payment may include the currency receiver 31 for validating the currency by scanning the currency and/or processing data pertaining to the currency received via the currency receiver 31 to determine if the currency is legitimate or fake.

In another example, the stored instructions for the payment transaction include receiving, via the user interface device, a payment recipient selection and a payment amount from the known user; sending a request to transfer funds equal in value to the payment amount from an account of the known user to an account of the payment recipient; and storing a payment transaction record of the payment transaction in the memory system. In certain examples, executing instructions for a payment transaction includes retrieving user account information from a central computing system, such as a financial institution, associated with the known user; and retrieving payment recipient account information from a financial institution associated with the payment recipient. In certain examples, the stored instructions further include instructions for performing an ATM transaction. In certain examples, the reconciliation process is performed daily. In other examples, the reconciliation is conducted multiple times a day. In some examples, the reconciliation process reconciles one or more selected accounts with one or more accounts related to the service provider. In some examples, the reconciliation process reconciles all the accounts associated with the transactions executed via the system during a given day with one or more accounts related to the service provider or financial institutions. Accordingly, in certain examples, the reconciliation(s) performed by the device 20 may not require reconciling transactions and/or user accounts with accounts of financial institutions to determine the balances of the accounts of the service provider (e.g., the account of the service provider that is related to the currency within the device). As such in these examples, the device 20 can reconcile the transactions and/or user accounts processed by the device 20 with the account(s) of the service provider without reconciling the transactions and/or user accounts with the accounts of external financial institutions. In certain examples, the user account information includes information and data pertaining to the account of the user such as account number, date of last transaction, associated financial institution, and/or balance of account.

In another example, sending a request to transfer funds between the user account and the service provider account includes submitting an Automated Clearing House payment request from the control system 10 to a central computing system to thereby initiate payment and/or transfer of funds between two accounts. The Automated Clearing House payment request can include any number of details or data related to the transaction including date, time, account numbers, and/or any other data pertaining to the transaction. In another example, the process includes retrieving from the database transaction type options associated with the known user and displaying the transaction type options on the user interface device.

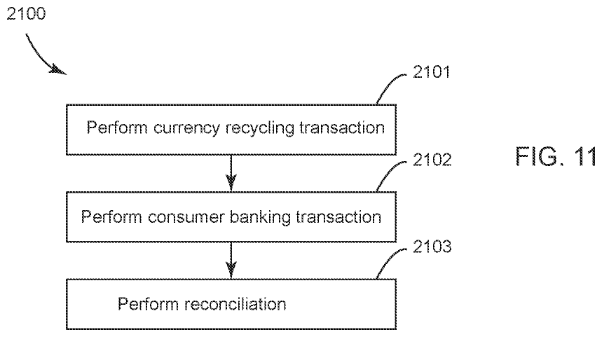

Referring to FIG. 11, another example process for operating the system 100 is depicted. The process 2100 begins at step 2101 by performing at least one currency recycling transaction that includes receiving, via the user interface device 34, user identification and a recycling transaction request from a first user. The recycling transaction request includes a recycling transaction amount, account details, and/or any other data pertaining to the transaction. The transaction further includes retrieving user account information associated with the user identification from a financial institution; transferring, via at least one of the currency receiver and the currency dispenser 32, currency equal in value to the recycling transaction amount between the system 100 and the first user; and storing a currency recycling transaction record of the currency recycling transaction in the memory system 203. Note that the user account information can be retrieved by the control system that sends a request to the central computing system or the user account information is stored on the memory system 203 and is retrieved by the control system 200.

At step 2102, the control system 200 performs at least one banking transaction that includes receiving, via a user interface device 34, user identification and a banking transaction request from a second user. The banking transaction can be any type of financial transaction that involves transfer of money into or out of an account, and the banking transaction request includes any information and/or data necessary to initiate the banking transaction such as user identification, amount of money to be transferred (e.g., a banking transaction amount), account information, and/or any other data pertaining to the banking transaction. The transaction further includes retrieving user account information associated with the user identification from a financial institution associated with the second user; transferring, via at least one of the currency receiver 31 and the currency dispenser 32, currency equal in value to the banking transaction amount between the system 100 and the second user; sending, a request to settle a balance equal in value to the transferred currency between the user account and a service provider account; and storing a banking transaction record of the banking transaction in the memory system. Note that the banking transaction record can include information or data pertaining to the banking transaction including date, time, account numbers, user information, financial institution information, and/or any other data pertaining to the transaction and the banking transaction amount can be retrieved by the control system that sends a request to the central computing system or the user account information is stored on the memory system 203 and is retrieved by the control system 201 be retrieved retrieving the banking transaction amount.

At step 2103, the control system 200 performs a reconciliation including determining, by the processing system 202, a net recycling transaction amount of at least one currency recycling transaction based on the currency recycling transaction records stored in the memory system 203; sending, a request to settle a balance equal in value to the net recycling transaction amount between the user account and the service provider account; determining, by the processing system 202, a net banking transaction amount of the at least one banking transaction based on the banking transaction records stored in the memory system 203; and determining, by the processing system 202, a currency inventory of the system 100 based on the net recycling transaction amount and the net banking transaction amount. Note that the request to settle the balance can be sent by the control system to the central computing system or the balance can be calculated and stored on the memory system 203 and is retrieved by the control system 200. The net banking transaction amount can be the summation of the deposits, withdraws, and/or transfers of currency or funds that are part of the banking transaction.

The processes described above can further one or more additional steps. In one example, the process includes performing at least one physical currency payment to a payment recipient. In this example, the user using the device 20 to make a payment to a third party by depositing physical currency into the device 20 via the currency receiver and then electronically transferring funds related to the amount of physical currency deposited into the device 20 to the account of the payment recipient (e.g., a physical currency payment). Note that in certain examples, the amount paid to the payment recipient may be equal to, greater than, or less than the amount received from the user via the currency receiver. In the event that the payment amount is greater than the currency received from the user via the currency receiver, additional funds are deducted from the associated account of the user to make up the difference between the payment amount and the currency received from the user. In the event that the payment amount is less than the currency received from the user via the currency receiver, the extra funds are added from the associated account of the user. In one example, the physical currency payment includes receiving, via the user interface device 43, a third user identification, a payment recipient selection, and a payment amount from a third user; transferring, via the currency receiver 31, currency equal in value to the payment amount from the third user to the system 100; retrieving recipient account information associated with the recipient identification from a financial institution associated with the payment recipient; sending a request to transfer funds equal in value to the payment amount from the service provider account to the account of the payment recipient; and storing a payment transaction record of the physical currency payment in the memory system 203. The payment transaction record includes date, time, amount, denominations, and/or the like. Note that the control system 200 may send signals to the central control system to retrieve recipient account information and/or send a request to transfer the funds. In other examples, the recipient account information and the request to transfer the funds is executed within the control system 200. In certain examples, performing the reconciliation includes determining, by the processing system 202, a net payment amount of at least one physical currency payment based on the payment transaction records stored in the memory system 203; and wherein determining the currency inventory is based on the net recycling transaction amount, the net banking transaction amount, and the net payment amount.

In another example, the process includes performing at least one payment electronically (e.g., an electronic payment) to a payment recipient including receiving, via the user interface, a fourth user identification, a payment recipient selection, and a payment amount from a fourth user; retrieving, fourth user account information from a financial institution associated with the fourth user; retrieving, payment recipient account information from a financial institution associated with the payment recipient; sending a request to electronically transfer funds equal in value to the payment amount from the account of the fourth user to the recipient account of the payment recipient; and storing a payment transaction record of the payment in the memory system 302. Note that the control system 200 can send signals to the central computing system to retrieve user identification and payment recipient account information or the retrieve user identification and payment recipient account information can be retrieved by the control system 200 from the memory system 203. Also note that in certain examples, the preforming the payment electronically involves transfer of funds between account(s) of the user and the account(s) of the third party payment reception without physical currency (e.g., bills, coins) being received via the device 20.

In certain examples, the processing system 202 is configured to execute store instructions retrieved from the memory system 203 including receiving, via the user interface, user identification from a user; determining if the user is a known user stored in a database of known users based on the received user identification; receiving, via the user interface, a transaction type selection from the known user; executing, by the processing system 202, stored instructions retrieved from the memory system 203 based on the transaction type selection, the stored instructions including instructions for the currency recycling transaction and instructions for the banking transaction based on the transaction type selection; and/or performing a reconciliation to determine a currency inventory of the system 100.

In another example process for the operating the system 100, the control executes one or more instructions stored on a memory system 203. The instructions can include one or more instructions. One example of instructions is for performing a currency recycling transaction. This transaction includes receiving user identification and a recycling transaction request from a first user using the user interface device 34, the recycling transaction request including a recycling transaction amount. Retrieving user account information associated with the user identification from a first financial institution; transferring, via at least one of the currency receiver 31 and the currency dispenser 32, currency equal in value to the recycling transaction amount between the cassette 33 of the system 100 and the first user; and storing a currency recycling transaction record of the currency recycling transaction in the memory system 203.

In another example, the instructions include performing a banking transaction (e.g., deposit into or withdraw out of account). This transaction includes receiving a user identification and a banking transaction request from a second user using the user interface device 34. The banking transaction request including a banking transaction amount. Retrieving user account information associated with the user identification from a financial institution associated with the second user; transferring via at least one of the currency receiver 31 and the currency dispenser 32, currency equal in value to the banking transaction amount between the cassette 33 of the system 100 and the second user; sending a request to settle a balance equal in value to the transferred currency between the user account and a service provider account; storing a banking transaction record of the banking transaction in the memory system 203.

In another example, the instructions include performing a reconciliation. This transaction includes determining, with the processing system 202, a net recycling transaction amount of the at least one currency recycling transaction based on the currency recycling transaction records stored in the memory system 203; sending a request to settle a balance equal in value to the net recycling transaction amount between the user account and the service provider account; determining, by the processing system 202, a net banking transaction amount of the at least one banking transaction based on the banking transaction records stored in the memory system 203; and determining, by the processing system 202, a currency inventory of the control system 200 based on the net recycling transaction amount and the net banking transaction amount.

In another example, the instructions include performing a physical currency payment. This transaction includes receiving, via the user interface device 34, a recipient identification of the payment recipient and a payment amount from a third user using the user interface device 34; receiving, via the currency receiver 31, currency equal in value to the payment amount from the third user to the system 100 and transfer the received currency to the cassette 33; retrieving recipient account information associated with the recipient identification from a financial institution associated with the payment recipient; sending a request to transfer funds equal in value to the payment amount from the service provider account to the recipient account of the payment recipient; and storing a payment transaction record of the physical currency payment in the memory system 203. Note that in certain examples recipient identification includes information and/or data regarding the name, account(s), and/or other details of the recipient.

In another example, the instructions include performing a payment. This transaction includes receiving, via the user interface device 34, a user identification, a recipient identification of the payment recipient and a payment amount from a fourth user using the user interface device 34; retrieving fourth user account information from a financial institution associated with the fourth user; retrieving recipient account information associated with the recipient identification from a financial institution associated with the payment recipient; sending a request to transfer funds equal in value to the payment amount from the account of the fourth user to the recipient account of the payment recipient; and storing a payment transaction record of the payment in the memory system 203.

It is to be appreciated that features depicted in conjunction with any one of the illustrated embodiments may be used in conjunction with the features of any other embodiment of the invention. In the above description, certain terms have been used for brevity, clarity, and understanding. No unnecessary limitations are to be inferred therefrom beyond the requirement of the prior art because such terms are used for descriptive purposes and are intended to be broadly construed. The different systems described herein may be used alone or in combination with other systems. It is to be expected that various equivalents, alternatives, and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of operating a currency management device of a service provider, the currency management device including a processing system, a memory system, a user interface, a currency receiver, and a currency dispenser, the method comprising steps for:
receiving, via the user interface, user identification from a user;
determining, by the processing system, if the user is a known user stored in a database of known users;
receiving, via the user interface device, a transaction type selection from the known user;
executing, by the processing system, stored instructions retrieved from the memory system based on the transaction type selection, the stored instructions including instructions for a currency recycling transaction and instructions for a payment transaction based on the transaction type selection;
performing a reconciliation to determine a currency inventory of the currency management device;
wherein executing instructions for the currency recycling transaction comprises:
receiving, via the user interface, a recycling transaction amount from the known user;
transferring, via at least one of the currency receiver and the currency dispenser, currency equal in value to the recycling transaction amount between the currency management device and the known user; and
storing a currency recycling transaction record of the currency recycling transaction in the memory system;
wherein executing instructions for the payment transaction comprises:
receiving, via the user interface, a payment recipient selection from the known user;
receiving, via the currency receiver, currency as a user payment from the known user;
sending, via a control system, a request to transfer funds equal in value to the user payment from an account of the service provider to an account of the payment recipient; and
storing a payment transaction record of the payment transaction in the memory system; and
wherein performing the reconciliation comprises:
determining, by the processing system, a net recycling transaction amount based on the currency recycling transaction records stored in the memory system;
sending a request to transfer funds proportional to the net recycling transaction amount between a user account and the service provider account;
determining, by the processing system, a net payment transaction amount based on the payment transaction records stored in the memory system; and
determining, by the processing system, the currency inventory based on the net recycling transaction amount and the net payment transaction amount.

2. The method according to claim 1, wherein the currency recycling transaction is a deposit and transferring currency between the currency management device and the known user includes:
receiving, via the currency receiver, a currency deposit from the known user; and
verifying, with the currency receiver, that the currency deposit is equal in value to the recycling transaction amount.

3. The method according to claim 1, wherein the currency recycling transaction is a withdrawal and transferring currency between the currency management device and the known user includes:
retrieving a user account balance from a financial institution associated with the user;
verifying, with the processing system, that the user account balance is greater than the recycling transaction amount; and
dispensing, with the currency dispenser, currency equal in value to the recycling transaction amount from the currency management device.

4. The method of claim 1, wherein executing instructions for the currency recycling transaction includes sending the currency recycling transaction record to a financial institution associated with the user.

5. The method of claim 1, wherein executing instructions for the payment transaction further comprises authenticating, with the currency receiver, the user payment as valid currency.

6. The method of claim 1, wherein the stored instructions for the payment transaction further comprise stored instructions for performing an electronic payment comprising:
receiving, via the user interface device, a payment recipient selection and a payment amount from the known user;
sending a request to transfer funds equal in value to the payment amount from an account of the known user to an account of the payment recipient; and
storing a payment transaction record of the electronic payment in the memory system.

7. The method of claim 6, wherein executing instructions for a payment transaction includes retrieving user account information from a financial institution associated with the known user; and
retrieving payment recipient account information from the financial institution associated with the payment recipient.

8. The method of claim 1, wherein the stored instructions further comprises instructions for performing an ATM transaction.

9. The method of claim 1, wherein the reconciliation is performed daily.

10. The method of claim 1, wherein sending a request to transfer funds between the user account and the service provider account includes submitting an Automated Clearing House payment request.

11. The method of claim 1, further comprising retrieving, from the database, transaction type options associated with the known user and displaying the transaction type options on the user interface device.

12. A currency management system for a retail environment, the currency management system comprising:
a currency receiver configured to receive currency into the currency management system;
a currency dispenser configured to dispense currency from the currency management system;
a cassette operatively connected to the currency receiver and the currency dispenser and configured to hold currency received by the currency management system;
a user interface device configured to receive user inputs and display information;
a control system commutatively connected to the currency receiver, the currency dispenser, the cassette, the user interface, and a central computing system, the processing system configured to execute stored instructions retrieved from a memory system including:
receiving, via the user interface, user identification from a user;
determining if the user is a known user stored in a database of known users based on the received identification information;
receiving, via the user interface, a transaction type selection from the known user;
executing, by the processing system, stored instructions retrieved from the memory system based on the transaction type selection, the stored instructions including instructions for a currency recycling transaction and instructions for a banking transaction based on the transaction type selection;
performing a reconciliation to determine a currency inventory of the currency management system;
wherein executing instructions for the currency recycling transaction comprises:
receiving, via the user interface, a recycling transaction amount from the known user;
transferring, via at least one of the currency receiver and the currency dispenser, currency equal in value to the recycling transaction amount between the currency management device and the known user;
storing a currency recycling transaction record of the currency recycling transaction in the memory system;
wherein executing instructions for the banking transaction comprises:
retrieving user account information from a financial institution associated with the known user;
receiving, via the user interface, a banking transaction amount from the known user;
transferring, via at least one of the currency receiver and the currency dispenser, currency equal in value to the banking transaction amount from the currency management device to the known user;
sending a request to transfer funds equal in value to the banking transaction amount from a user account to a service provider account;
storing a banking transaction record of the banking transaction in the memory system;
wherein executing instructions for the reconciliation comprises:
determining, by the processing system, a net recycling transaction amount based on the currency recycling transaction records stored in the memory system;
sending a request to transfer funds proportional to the net recycling transaction amount between a user account and the service provider account;
determining, by the processing system, a net banking transaction amount based on the payment transaction records stored in the memory system; and
determining, by the processing system, the currency inventory based on the net recycling transaction amount and the net banking transaction amount.

13. A currency management system for a retail environment, the currency management system comprising:
a currency receiver configured to receive currency into the currency management system;
a currency dispenser configured to dispense currency from the currency management system;
a cassette operatively connected to the currency receiver and the currency dispenser and configured to hold currency in the currency management system;
a user interface configured to receive user inputs and display information;
a processing system commutatively connected to the currency receiver, the currency dispenser, the cassette, and the user interface, the processing system configured to execute stored instructions stored on a memory system;
wherein the stored instructions include instructions to perform a currency recycling transaction by executing instructions to:
receive user identification and a recycling transaction request from a first user using the user interface, the recycling transaction request including a recycling transaction amount;
retrieve user account information associated with the user identification from a first financial institution;
transfer, via at least one of the currency receiver and the currency dispenser, currency equal in value to the recycling transaction amount between the cassette of the currency management system and the first user;
store a currency recycling transaction record of the currency recycling transaction in the memory system
wherein the stored instructions include instructions to perform a banking transaction by executing instructions to:
receive a user identification and a banking transaction request from a second user using the user interface, the banking transaction request including a banking transaction amount;
retrieve account information associated with the user identification from a financial institution associated with the second user;
transfer, via at least one of the currency receiver and the currency dispenser, currency equal in value to the banking transaction amount between the cassette of the currency management system and the second user;
send, a request to settle a balance equal in value to the transferred currency between the user account and a service provider account;
store a banking transaction record of the user transaction in the memory system;
wherein the stored instructions include instructions to perform a reconciliation by executing instructions to:
determine, by the processing system, a net recycling transaction amount of the at least one currency recycling transaction based on the currency recycling transaction records stored in the memory system;
send a request to settle a balance equal in value to the net recycling transaction amount between the user account and the service provider account;
determine, by the processing system, a net banking transaction amount of the at least one banking transaction based on the banking transaction records stored in the memory system; and
determine, by the processing system, a currency inventory of the currency management system based on the net recycling transaction amount and the net banking transaction amount.

14. The currency management system of claim 13, wherein the stored instructions further comprise instructions to perform a physical currency payment by executing instructions to:
receive, via the user interface, a recipient identification of a payment recipient and a payment amount from a third user using the user interface;
receive, via the currency receiver, currency equal in value to the payment amount from the third user to the currency management system and transfer the received currency to the cassette;
retrieve recipient account information associated with the recipient identification from a financial institution associated with the payment recipient;
send a request to transfer funds equal in value to the payment amount from the service provider account to the recipient account of the payment recipient; and
store a payment transaction record of the physical currency payment in the memory system.

15. The currency management system of claim 13, wherein the stored instructions further comprise instructions to perform an electronic payment by executing instructions to:
receive, via the user interface, a user identification, a recipient identification of the payment recipient and a payment amount from a fourth user using the user interface;
retrieve fourth user account information from a financial institution associated with the fourth user;
retrieve recipient account information associated with the recipient identification from a financial institution associated with the payment recipient;
send a request to transfer funds equal in value to the payment amount from the account of the fourth user to the recipient account of the payment recipient; and
store a payment transaction record of the electronic payment in the memory system.

16. The currency management system of claim 13, wherein the currency receiver comprises a currency validator configured to authenticate currency received by the currency receiver as valid.

17. The currency management system of claim 13, wherein the cassette is one of a system comprises a plurality of cassettes that are each operatively connected to the currency receiver and the currency dispenser and configured to hold currency in the currency management system; and
wherein a first one of the plurality of cassettes is configured to hold a first type of currency and a second one of the plurality of cassettes is configured to hold a second type of currency.

18. A method of operating a currency management system, the currency management system including a processing system, a memory system, a user interface, a currency receiver and a currency dispenser, the method comprising steps for:
performing at least one currency recycling transaction, each currency recycling transaction comprising:
receiving, via the user interface, a user identification and a recycling transaction request from a first user, the recycling transaction request including a recycling transaction amount;
retrieving user account information associated with the user identification from a financial institution or another financial institution;
transferring, via at least one of the currency receiver and the currency dispenser, currency equal in value to the recycling transaction amount between the currency management system and the first user;
storing a currency recycling transaction record of the currency recycling transaction in the memory system;
performing at least one banking transaction, each banking transaction comprising:
receiving, via a user interface, a user identification and a banking transaction request from a second user, the banking transaction request including a banking transaction amount;
retrieving user account information associated with the user identification from a financial institution associated with the second user;
transferring, via at least one of the currency receiver and the currency dispenser, currency equal in value to the banking transaction amount between the currency management system and the second user;
sending a request to settle a balance equal in value to the transferred currency between the user account and a service provider account;
storing a banking transaction record of the user transaction in the memory system;
performing a reconciliation comprising:
determining, by the processing system, a net recycling transaction amount of the at least one currency recycling transaction based on the currency recycling transaction records stored in the memory system;
sending a request to settle a balance equal in value to the net recycling transaction amount between the user account and the service provider account;
determining, by the processing system, a net banking transaction amount of the at least one banking transaction based on the banking transaction records stored in the memory system; and
determining, by the processing system, a currency inventory of the currency management system based on the net recycling transaction amount and the net banking transaction amount.

19. The method of claim 18, further comprising performing at least one payment recipient currency payment to a payment recipient, each physical currency payment comprising:
receiving, via the user interface, a third user identification, a payment recipient selection, and a payment amount from a third user;
transferring, via the currency receiver, currency equal in value to the payment amount from the third user to the currency management system;
retrieving recipient account information associated with the recipient identification from a financial institution associated with the payment recipient;
sending a request to transfer funds equal in value to the payment amount from the service provider account to the account of the payment recipient; and
storing a payment transaction record of the physical currency payment in the memory system;
wherein performing a reconciliation further comprises determining, by the processing system, a net payment amount of the at least one physical currency payment based on the payment transaction records stored in the memory system; and
wherein determining the currency inventory is based on the net recycling transaction amount, the net banking transaction amount, and the net payment amount.

20. The method of claim 19, further comprising performing at least one payment to an payment recipient, each payment comprising:
receiving, via the user interface, a fourth user identification, a payment recipient selection, and a payment amount from a fourth user;
retrieving fourth user account information from a financial institution associated with the fourth user;
retrieving payment recipient account information from a financial institution associated with the payment recipient;
sending a request to transfer funds equal in value to the payment amount from the account of the fourth user to the recipient account of the payment recipient; and
storing a payment transaction record of the payment in the memory system.
